(19) United States
(12) Patent Application Publication
(10) Pub. No.: US 2010/0243965 A1
(43) Pub. Date: Sep. 30, 2010

(54) Process for preparing a thermosetting composite material with a high nanotube content

(75) Inventors: Alexander KORZHENKO, Pau (FR); Pierre MIAUDET, Jurancon (FR); Amelie MERCERON, Aussevielle (FR); Patrice GAILLARD, Hagetaubin (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: ARKEMA FRANCE, COLOMBES (FR)

(21) Appl. No.: 12/728,504

(22) Filed: Mar. 22, 2010

Related U.S. Application Data
(60) Provisional application No. 61/235,466, filed on Aug. 20, 2009.

(30) Foreign Application Priority Data
Mar. 23, 2009 (FR) 0951842

(51) Int. Cl. H01B 1/24

(52) U.S. Cl. 252/511; 252/500; 977/742

(57) ABSTRACT

The present invention provides a process for preparing a composite material containing from 15% to 60% by weight of nanotubes, comprising:
(a) introducing into a compounding device a liquid polymer composition comprising at least one thermosetting resin in the liquid state, nanotubes and optionally a rheology modifier,
(b) mixing the polymer composition and the nanotubes within said device, to form a composite material,
(c) recovering the composite material, optionally after conversion to an agglomerated solid physical form such as granules.

The invention likewise relates to the composite material thus obtained, and also to its use for manufacturing a composite product.

The present invention relates to a process for preparing a composite material based on thermosetting resin and on nanotubes, especially carbon nanotubes, to the composite material thus obtained, and also to its use for manufacturing composite products.

Thermosetting materials such as epoxy resins are known to exhibit, in particular, outstanding corrosion resistance and solvent resistance properties, effective adhesion to a variety of substrates, and a thermal stability which is greater than that of thermoplastics. For certain applications, and especially for the manufacture of electrostatic shields intended for the packaging of electronic devices, it may be useful to endow these thermosetting resins additionally with properties of electrical conduction and/or to enhance their mechanical properties. To accomplish this it is possible to incorporate conductive fillers such as carbon nanotubes (or CNTs) into said resins.

The nanotubes must be incorporated into the thermosetting resin before it is cured. However, the attempts made to date to incorporate CNTs—having a highly entangled structure—into thermosetting resins have come up against the formation of CNT aggregates which require the use of ball mills or mixers with very high shear in order to disrupt the aggregates. Moreover, the CNTs make the resin highly viscous. Consequently, in practice, the level of incorporation of CNTs into thermosetting resins is presently limited to 1.5% to 2% by weight.

Thus, document U.S. Pat. No. 5,744,235 describes a process for preparing composite material comprising fillers such as carbon fibers or glass fibers, carbon whiskers or silicon carbide whiskers, particles of silica or of carbon black, or else carbon fibrils in a metallic, ceramic or organic-resin matrix such as elastomers, thermoplastic resins or thermosetting resins. This process includes a step a) of mixing the fillers in the matrix and then submitting this mixture to a step b) of shearing and applying forces in order to reduce the size of the aggregates of fillers to a value of not more than 1000 times the size of the initial aggregates. Step b) is carried out with a conventional ball mill. This process is not at all appropriate for reducing the size of carbon nanotubes obtained by a catalytic process in vapor phase (catalyst chemical vapor deposition) to a size allowing them to be introduced homogeneously into an organic matrix.

Furthermore, document WO 2009/018193 discloses a composition comprising an epoxy resin, an amphiphilic reinforcing agent, an inorganic nanofiller and optionally a curing agent, in which composition the nanofiller may represent, for example, from 0.1% to 50% by weight of the epoxy resin. Among the nanofillers which can be used, mention is made of carbon nanotubes. However, the sole example of this document employs 2.5% by weight of silica nanoparticles. In practice it is not possible to obtain composite materials with 5% by weight or more of CNTs, let alone masterbatches containing at least 25% by weight of CNTs, by following the teaching of that document.

Other solutions have been proposed for producing thermosetting CNT/polymer composites using kneading devices.

Thus, document FR 2 893 947 describes a spray composition that includes CNTs placed in contact (in particular impregnated) with a compound A, which can be highly variable, in particular a thermosetting resin. Example 6 of this document thus discloses a DER 332-type thermosetting resin, which is mixed with CNTs (50% by weight) in a “Rheocord micro-kneader”.

In addition, document US 2007/238826 discloses a process for preparing conductive thermosetting materials, which consists of subjecting a composition containing CNTs and a thermosetting resin of adequate viscosity (i.e. in practice, over 15 poises) to an extrusion process. This resin can be in liquid or solid form. The extrusion can be performed in various devices, including a single-screw or a dual-screw extruder or a Buss® co-kneader.

In Example 1 of this document, an EPON® 1001 F resin is introduced into a dual-screw extruder in the molten state, after impregnation with CNTs representing 5% of the weight of the composition. It is indicated that the viscosity of the mixture is too low (4.4 poises) for the process to be capable of being conveniently implemented. In Example 2, an EPON 1009 F resin is introduced into a dual-screw extruder in solid form, after pre-impregnation with 15% by weight CNT.

It is still however desirable to have a means available for allowing simple and homogeneous dispersion, on the industrial scale, of high levels of CNTs in a thermosetting resin for the purpose of manufacturing masterbatches or precomposites which can be easily manipulated and then diluted in a polymer matrix to form composite components.

In this context the Applicant has found that this need can be met by introducing the thermosetting resin in the liquid state into a compounding device in which it is kneaded with the nanotubes.

The present invention accordingly provides a process for preparing a composite material containing from 15% to 60% by weight of nanotubes, comprising:
(a) introducing into a compounding device a liquid polymer composition comprising at least one thermosetting resin in the liquid state, nanotubes and optionally a rheology modifier,
(b) mixing the polymer composition and the nanotubes within said device, to form a composite material,
(c) recovering the composite material, optionally after conversion to an agglomerated solid physical form such as granules.

A “compounding device” for the purposes of the present description is an apparatus which is conventionally used in the plastics industry for the mixing in the melt state of thermoplastic polymers and additives with the aim of producing composites. In this apparatus the polymer composition and the additives are mixed by means of a high-shear device, for example a co-rotating twin-screw extruder or a co-kneader. The melted material generally exits the apparatus either in an agglomerated solid physical form such as granules, or in the form of rolls, ribbon or film.

Examples of co-kneaders which can be used according to the invention are the BUSS® MDK 46 co-kneaders and those of the BUSS® MKS or MX series, which are sold by BUSS AG, and which are all composed of a screw shaft provided with flights, arranged in a heating barrel optionally composed of a plurality of sections, and in which the inner wall is provided with kneading teeth which are set up to cooperate with the flights to produce shearing of the kneaded material. The shaft is driven in rotation and is provided with an oscillating movement in the axial direction by means of a motor. These co-kneaders may be equipped with a granule manufacturing system, fitted for example to their outlet orifice, which may be composed of an extrusion screw or a pump.

The co-kneaders which can be used according to the invention preferably have a screw ratio L/D of from 7 to 22, for example from 10 to 20, whereas the co-rotating extruders advantageously have an L/D ratio of from 15 to 56, for example from 20 to 50.

The Applicant has demonstrated that this process allows composite materials, more particularly masterbatches, to be obtained which can have a high level of nanotubes added, such as CNTs, and which are readily manipulable, where they take the form of granules, in the sense that they can be transported in bags from the production centre to the conversion centre. These composite materials may, moreover, be shaped by the methods which are conventionally used for the shaping of thermoplastic materials, such as extrusion, injection molding or compression molding, in contrast to the thermosetting composites of the prior art, which generally require casting in moulds.

A “thermosetting resin”, for the purposes of the present description, is a material which is generally liquid at room temperature, or at low melting point (maximum of 100° C.), and which can be cured, generally in the presence of a curing agent, under the effect of heat, a catalyst or a combination of the two, to give a thermoset resin. This resin is composed of a material containing polymer chains of variable length which are joined to one another by covalent bonds, so as to form a three-dimensional network. With regard to its properties, this thermoset resin is infusible and insoluble. It can be softened by heating it above its glass transition temperature (Tg); however, once it has been given a shape, it cannot be reshaped subsequently by heating.

Thermosetting resins which can be used according to the invention include the following: unsaturated polyesters, epoxy resins, vinyl esters, phenolic resins, polyurethanes, cyanoacrylates and polyimides, such as bismaleimide resins, amino resins (resulting from the reaction of an amine such as melamine with an aldehyde such as glyoxal or formaldehyde) and mixtures thereof, without this list being limitative.

Unsaturated polyesters result from the polycondensation of dicarboxylic acids containing an unsaturated compound (such as maleic anhydride or fumaric acid) and glycols such as propylene glycol. They are generally cured by dilution in a reactive monomer, such as styrene, followed by reaction of the latter with the unsaturations present on these polyesters, generally with the aid of peroxides or a catalyst, in the presence of salts of heavy metals or an amine, or else with the aid of a photoinitiator, of ionizing radiation or of a combination of these various techniques.

Vinyl esters comprise the products of the reaction of epoxides with (meth)acrylic acid. They may be cured following dissolution in styrene (similarly to the polyester resins) or with the aid of organic peroxides.

Epoxy resins are composed of materials containing one or more oxirane groups, for example from 2 to 4 oxirane functions per molecule. Where they are polyfunctional, these resins may be composed of linear polymers which carry terminal epoxy groups, or whose backbone contains epoxy groups, or else whose backbone carries pendant epoxy groups. As a curing agent they generally require an acid anhydride or an amine.

These epoxy resins may result from the reaction of epichlorohydrin with a bisphenol such as bisphenol A. As a variant, the compounds in question may be alkyl and/or alkenyl glycidyl ethers or esters; optionally substituted monophenol and polyphenol polyglycidyl ethers, especially polyglycidyl ethers of bisphenol A; polyglycidyl ethers of polyols; polyglycidyl ethers of aliphatic or aromatic polycarboxylic acids; polyglycidyl esters of polycarboxylic acids; polyglycidyl ethers of novolac. In a further variant, the compounds in question may be products of the reaction of epichlorohydrin with aromatic amines or with glycidyl derivatives of aromatic monoamines or diamines. In this invention it is also possible to use cycloaliphatic epoxides. According to the invention it is preferred to use diglycidyl ethers of bisphenol A (or DGEBA), F or A/F.

The nanotubes intended for mixing with the thermosetting resin according to the invention may be carbon nanotubes (CNTs hereinafter) or nanotubes based on boron, phosphorus or nitrogen, or else nanotubes containing two or more of these elements or at least one of these elements in combination with carbon. Advantageously they are carbon nanotubes. These nanotubes possess particular crystalline structures, of tubular, hollow and closed form, which are composed of atoms arranged regularly in pentagons, hexagons and/or heptagons, which are obtained from carbon. The CNTs are generally composed of one or more rolled graphite leaflets. Thus distinctions are made between single-wall nanotubes (or SWNT) and multi-wall nanotubes (MWNT). Double-wall nanotubes may in particular be prepared as described by Flahaut et al. in Chem. Com. (2003), 1442. Multi-wall nanotubes may for their part be prepared as described in document WO 03/02456. It is preferable according to the invention to use multi-wall CNTs.

The nanotubes implemented according to the invention typically have an average diameter of from 0.1 to 200 nm, preferably from 0.1 to 100 nm, more preferably from 0.4 to 50 nm and even more preferably from 1 to 30 nm, and advantageously a length of more than 0.1 μm and advantageously from 0.1 to 20 μpm, for example approximately 6 μm. Their length/diameter ratio is advantageously greater than 10 and usually greater than 100. These nanotubes therefore comprise, in particular, nanotubes referred to as “VGCF” (carbon fibers obtained by chemical deposition in vapor phase, or Vapor Grown Carbon Fibers). Their specific surface area is, for example, between 100 and 300 m²/g, and their apparent density may in particular be between 0.01 and 0.5 g/cm³ and more preferably between 0.07 and 0.2 g/cm³. The multi-wall carbon nanotubes may, for example, contain 5 to 15 leaflets and more preferably from 7 to 10 leaflets.

One example of untreated carbon nanotubes is in particular available commercially from Arkema under the trade name Graphistrength® C100.

The nanotubes may be purified and/or treated (especially oxidized) and/or ground before being employed in the process according to the invention. They may also be functionalized by methods of chemistry in solution, such as amination or reaction with coupling agents.

The nanotubes may in particular be ground cold or hot and may be ground in accordance with the known techniques employed in apparatus such as ball mills, hammer mills, edge runner mills, impeller breakers, gas jets or any other grinding system capable of reducing the size of the entangled network of nanotubes. This grinding step is preferably performed by a technique of grinding with gas jets, and in particular in an air-jet mill.

The nanotubes may be purified by washing using a solution of sulphuric acid, or of another acid, in order to remove any residual metallic and mineral impurities from them, originating from their production process. The weight ratio of the nanotubes to the sulphuric acid may in particular be between 1:2 and 1:3. The purifying operation may, furthermore, be carried out at a temperature of from 90 to 120° C., for example for a time of 5 to 10 hours. This operation may advantageously be followed by steps of rinsing with water and drying of the purified nanotubes. Another route to purification of the nanotubes, intended in particular for removing the iron and/or magnesium and/or alumina that they contain, involves subjecting them to a heat treatment at more than 1000° C.

The nanotubes are advantageously oxidized by contacting them with a solution of sodium hypochlorite containing from 0.5% to 15% by weight of NaOCl and preferably from 1% to 10% by weight of NaOCl, in a weight ratio, for example, of the nanotubes to the sodium hypochlorite of from 1:0.1 to 1:1. The oxidation is advantageously performed at a temperature less than 60° C. and preferably at room temperature, for a time of from a few minutes to 24 hours. This oxidizing operation may advantageously be followed by steps of filtration and/or centrifugation, washing and drying of the oxidized nanotubes.

It is preferred, however, for the nanotubes to be used in the process according to the invention in the crude state.

Moreover, it is preferred in accordance with the invention to use nanotubes obtained from renewable raw materials, especially plant-based raw materials, as described in document FR 2 914 634.

The amount of nanotubes employed according to the invention represents from 15% to 60% by weight, and preferably from 20 to 50% by weight, with respect to the total weight of the composite material. The exact amount of nanotubes implemented may vary within these ranges, according to whether the desired composite material is intended for direct conversion to a composite component or takes the form of a masterbatch intended for dilution in a polymer matrix.

A masterbatch which is preferred according to the invention comprises from 20% to 30% by weight, preferably 25% by weight, of carbon nanotubes in an epoxy resin, preferably a diglycidyl ether of bisphenol A. Such a masterbatch is available from the Company ARKEMA under the trade name Graphistrength® C S1-25.

The process according to the invention enables composite materials to be produced simply, without requiring a preliminary nanotube impregnation step. Nevertheless, the nanotubes may be introduced into the compounding device either via a feed hopper separate from the area where the thermosetting polymer is injected, or as a mixture with said polymer.

In the first step of the process according to the invention, the thermosetting resin is introduced into the compounding device in the liquid state. By “liquid”, we mean that the resin is capable of being pumped into the compounding device, i.e. it advantageously has a dynamic viscosity ranging from 0.1 to 30 Pa·s, and preferably 0.1 to 15 Pa·s. The resin used can have this viscosity at room temperature (23° C.) or else be heated prior to injection into the compounding apparatus, in order to give it the aforementioned viscosity. In this case, it is preferred that its melting point does not exceed 100° C.

Moreover, the viscosity of the resin may be adjusted by admixing it with one or more rheology modifiers, such as, for example, a reactive or non-reactive solvent. These modifiers may be included in the polymer composition containing the thermosetting resin.

The measurement of dynamic viscosity is based on a general method for determining viscoelastic properties of polymers in the liquid state, the molten state or the solid state. The samples are subjected to deformation (or stress), usually sinusoidal in tension, compression, bending or twisting for solids, and shear for liquids. The response of the samples to this stress is evaluated either by the force or the resulting torque, or by the deformation when working with imposed stresses. The viscoelastic properties are thus determined in terms of modulus or viscosity, or in terms of creep or relaxation function. In flow, the samples are subjected to a series of stresses and/or deformations in order to predict their behavior according to the shear value.

For this determination, a viscoelasticity meter, comprised of the following elements, is used:
A chamber or a thermal control system (the atmosphere during the test can be either liquid and/or gaseous nitrogen or air)
A central control unit
A system for controlling the flow rate and the drying of the air and the nitrogen
A measurement head
A computer system for controlling the apparatus and processing data
“Sample holders”

The RDA2, RSA2, DSR200, ARES or RME of the manufacturer Rheometrics, or MCR301 of Anton Paar can be cited as examples of equipment that can be used.

The sample sizes are defined according to the viscosity thereof and the geometric limits of the chosen “sample holder” system.

To conduct a test and determine the dynamic viscosity of a thermosetting resin, the steps described in the manual of use of the viscoelasticity meter used will be methodologically followed. In particular, it will be ensured that the relationship between deformation and stress is linear (linear viscoelasticity).

One example of a rheology modifier is an acrylic block copolymer such as the triblock poly(methyl methacrylate)/poly(butyl acrylate)/poly(methyl methacrylate) copolymer available from Arkema under the trade name Nanostrength® M52N. A copolymer of this kind is particularly well suited to use in an epoxy resin, into which it can be introduced in the form of a powder and dissolved with stirring in order to enhance its viscosity. This copolymer also allows the dispersion of the nanotubes to be improved, by facilitating the transfer of mechanical energy in the course of shearing in the compounding tool, and also facilitates the formation of granules from the thermosetting resin. In a variant, it is possible to use a polystyrene/poly-1,4-butadiene/poly(methyl methacrylate) copolymer, which is also sold by Arkema under the Nanostrength® name.

Another example of a rheology modifier agent is a branched fatty acid glycidyl ester such as the highly branched C10 carboxylic acid glycidyl ester sold by Hexon under the trade name Cardura® E10. In addition to its effect of reducing the viscosity, this compound is also capable of reacting with the curing agent of the epoxy resins. Added at the end of compounding, it also reduces the risks of crosslinking of the epoxy resins, by cooling the medium.

Further to these rheology modifiers, the polymer composition used according to the invention may contain various additives such as graphene-based fillers other than nanotubes (especially fullerenes), silica or calcium carbonate; UV filters, based in particular on titanium dioxide; flame retardants; and mixtures thereof. Alternatively or additionally the polymer composition may contain at least one solvent for the thermosetting resin. It may additionally contain expanding agents, especially preparations based on azodicarbonic acid diamide such as those sold by Lanxess under the trade name Genitron®. These are compounds which undergo decomposition at 140-200° C. to form, in the compounding step, cavities in the composite material which facilitate its subsequent introduction into a polymer matrix. Other additives which can be used are the curing agents of the thermosetting resin, with the proviso that their activation temperature is greater than the compounding temperature.

The compounding step is generally implemented at a temperature which is dependent on the polymer specifically used and which is generally referred to by the supplier of the polymer. By way of example, the compounding temperature may range from 20° C. to 260° C., for example from 30° C. to 260° C. and particularly from 80° C. to 120° C.

At the end of the process according to the invention, a composite material is obtained which may, after cooling, advantageously be in a solid form which can be used directly. The invention further provides the composite material obtainable by the above process.

This composite material may be used as it is, in other words shaped according to any appropriate technique, in particular by injection, extrusion, compression or molding, followed by treatment at 140-150° C., for example, in order to activate the curing agent. The curing agent may either have been added to the composite material during the compounding step (where its activation temperature is greater than the compounding temperature) or may be added to the composite material immediately prior to its shaping.

In this embodiment, the composite material according to the invention can thus be used to manufacture films, pre-impregnated materials, ribbons, profiles, strips or fibres. For this purpose, it is possible to provide at the outlet of the compounder a die for shaping the composite material.

In a variant, the composite material according to the invention may be used as a masterbatch and may therefore be diluted in a polymer matrix to form a composite product after shaping and heat treatment. Here again, the curing agent may be introduced during the compounding step, or during the formulation of the polymer matrix, or else during the shaping of the polymer matrix. In this form of implementation of the invention, the composite end product may contain from 0.001 to 10% by weight of nanotubes, generally from 0.5% to 5% by weight of nanotubes, preferably from 0.1 to 2% by weight of nanotubes.

The invention further provides for the use of the composite material described above for manufacturing a composite product and/or for the purpose of imparting at least one electrical, mechanical and/or thermal property to a polymer matrix.

The invention also provides a process for manufacturing a composite product, comprising:
manufacturing a composite material by the process described above, and
introducing the composite material into a polymer matrix.

The polymer matrix generally contains at least one polymer selected from thermosetting homopolymers or gradient, block, random or sequenced copolymers. In accordance with the invention it is preferred to use at least one thermosetting resin selected from those listed above.

The polymer matrix may further include at least one curing agent and/or a curing catalyst for the thermosetting resin, as indicated above, and also various adjuvants and additives such as lubricants, pigments, stabilizers, fillers or reinforcements, antistats, fungicides, flame retardants and solvents.

Advantageously, when it is in the form of granules, the masterbatch is first immersed in a part of the polymer matrix for several hours, for instance overnight, and optionally heated, for instance at about 80° C., in order to soften the granules before introducing them into the rest of the polymeric matrix. One can make use of heating means such as microwaves or induction which enable to use the resistive properties of the CNT and to heart heat the masterbatch very fast. The mixture is then preferably subjected to high shear, for instance by means of a rotor stator device. It is then possible to add the additives of the polymer matrix to the mixture.

In this embodiment of the invention, the compounder, inside which the masterbatch is manufactured, can be coupled with another device intended to be supplied, on the one hand, by the masterbatch, and, on the other hand, by the polymer matrix described above. This other device can in this case be equipped with a die for shaping the composite product formed.

The invention will be better appreciated in light of the following examples, which are not limitative and are purely illustrative.

### EXAMPLES

### Example 1

### Manufacture of a Masterbatch Based on Epoxy Resin

Introduced into the first feed hopper of a BUSS° MDK 46 co-kneader (L/D=11), equipped with an extrusion screw and a granulation device, were carbon nanotubes (Graphistrength® C100 from Arkema) and an acrylic copolymer powder (Nanostrength M52N from Arkema). An epoxy resin base (DGEBA or diglycidyl ether of bisphenol A) was injected in liquid form at 80° C. into the first zone of the co-kneader. The set point temperatures within the co-kneader were as follows: Zone 1=120° C., Zone 2=120° C., Screw=80° C. The throughput was regulated at 15 kg/h.

At the outlet of the apparatus, granules were obtained of a masterbatch containing 35% by weight of nanotubes, 45% by weight of epoxy resin and 20% by weight of acrylic copolymer.

These granules can be subsequently diluted in a polymer matrix, in an apparatus allowing heating to 130-140° C.

### Example 2

### Manufacture of a Masterbatch Based on Epoxy Resin

In the same co-kneader as described in Example 1, a formulation was prepared which contained 25% by weight of carbon nanotubes, 70% by weight of epoxy resin and 5% by weight of a reactive diluent (Cardura E10P from Hexon).

The nanotubes were introduced into the first feed hopper of the co-kneader. The epoxy resin was injected at 80° C. into the first zone of the co-kneader and the diluent was injected at 40° C. into the second zone of the co-kneader. After kneading, at the outlet of the rework extruder heated to 70-80° C., a solid composite material was obtained at the exit of the die, which was packaged directly without granulation.

This masterbatch may be diluted in a thermosetting formulation at room temperature to manufacture a composite product.

Pre-impregnation of this masterbatch in a liquid component of the thermosetting formulation, for several hours, makes it even easier to introduce into the formulation.

1. Process for preparing a composite material containing from 15% to 60% by weight of nanotubes, comprising:
(a) introducing into a compounding device a liquid polymer composition comprising at least one thermosetting resin in the liquid state, nanotubes and optionally a rhology modifier,
(b) mixing the polymer composition and the nanotubes within said device, to form a composite material,
(c) recovering the composite material, optionally after conversion to granules.

2. Process according to claim 1, characterized in that the compounding device is a co-rotating twin-screw extruder, preferably having a screw ratio L/D of from 15 to 56, more preferably from 20 to 50.

3. Process according to claim 1, characterized in that the compounding device is a co-kneader preferably having a screw ratio L/D of from 7 to 22, more preferably from 10 to 20.

4. Process according to claim 1, characterized in that the polymer composition comprises at least one thermosetting resin selected from the following: unsaturated polyesters, epoxy resins, vinyl esters, phenolic resins, polyurethanes, cyanoacrylates and polyimides, such as bismaleimide resins, amino resins (resulting from the reaction of an amine such as melamine with an aldehyde such as glyoxal or formaldehyde) and mixtures thereof.

5. Process according to claim 1, characterized in that the nanotubes are carbon nanotubes.

6. Process according to claim 1, characterized in that the composite material contains from 20% to 50% by weight of nanotubes, relative to the total weight of the composite material.

7. Composite material obtainable by the process according to claim 1.

8. A method of using a composite material according to claim 7 comprising manufacturing a composite product and/or for the purpose of imparting at least one electrical mechanical and/or thermal property to a polymer matrix with said composite material.

9. A method of using a composite material according to claim 7 comprising manufacturing films, pre-impregnated materials, ribbons, profiles, strips or fibers with said composite material.

10. Process for manufacturing a composite product, comprising:
manufacturing a composite material by the process according to claim 1, and
introducing the composite material into a polymer matrix.
